(19) United States
(12) Patent Application Publication
(10) Pub. No.: US 2026/0104850 A1
(43) Pub. Date: Apr. 16, 2026

(54) AUDIO PLAYBACK METHOD, AUDIO PLAYBACK SYSTEM, AND TRANSMITTING SPEAKER

(71) Applicant: Realtek Semiconductor Corporation, Hsinchu (TW)

(72) Inventor: Tzu-Hsuan WENG, Hsinchu (TW)

(21) Appl. No.: 19/358,448

(22) Filed: Oct. 15, 2025

(30) Foreign Application Priority Data
Oct. 15, 2024 (TW) 113139212

(51) Int. Cl. G06F 3/16; G06F 13/20; H04R 3/12

(52) U.S. Cl. CPC G06F 3/165; G06F 3/162; G06F 13/20; H04R 3/12; G06F 2213/40; H04R 2420/07

(57) ABSTRACT

An audio playback method includes: (a) successively transmitting multiple timestamp capturing instructions by a system on chip, to command a wireless communication chip to capture multiple timestamps, respectively; (b) capturing, by the system on chip, multiple corresponding system time points, in response to the timestamp capturing instructions; and (c) generating a corresponding time difference corresponding to the timestamp capturing instructions, according to the corresponding timestamps and the corresponding system time points. The step (b) includes: when receiving each timestamp capturing instruction, sending, by the wireless communication chip, an input/output signal and a corresponding timestamp currently-captured to the system on chip through a first input-output interface and a communication interface, respectively, to trigger a system interrupting when the system on chip receives the input/output signal; and capturing, by the system on chip, a current system time point as a corresponding system time point corresponding to a current timestamp capturing instruction.

### RELATED APPLICATIONS

This application claims priority to Taiwan Application Serial Number 113139212, filed on Oct. 15, 2024, which is herein incorporated by reference in its entirety.

### BACKGROUND

### Technical Field

Embodiments described in the present disclosure relate to an audio technology. More particularly, the embodiments described in the present disclosure relate to a playback method, an audio playback system and a transmitting speaker.

### Description of Related Art

In previous practices, creation of a stereo surround sound effect can be achieved by multiple speakers playing back the same audio file simultaneously. In the prior art, multiple wireless communication speakers are communicably connected to a transmitting speaker that can be used as a wireless access point (AP), the transmitting speaker acts as a bridge for the multiple wireless communication speakers to transmit a wireless signal (which can be a beacon signal) containing co-playback time point information to each of the wireless communication speakers, and then the wireless communication speakers determine their playback time points based on the co-playback time point information. In this way, the playback time points of all the wireless speakers are unified.

However, the transmitting speaker itself should also play back an audio in sync with the wireless speakers. Under the hardware configuration of the existing transmitting speaker, this requires that the co-playback time point information is sent to a system on chip of the transmitting speaker through a bus (e.g., USB 2.0), and then the system on chip determines a playback time point of the transmitting speaker according to the co-playback time point information. The co-playback time point information is a timestamp captured when the wireless signal is transmitted. In other words, the co-playback information takes the timestamp of the wireless signal as a time standard, but is not a system time point of the system on chip. Therefore, it is necessary to align the system time point of the transmitting speaker with a time point marked by the timestamp, that is, to compensate for a difference between the system time point and the time point marked by the timestamp, so that the transmitting speaker can play back the audio in sync with other communication speakers according to the co-playback time point information. The time required for the bus transmission described above is often difficult to estimate and is non-negligible, causing that it is difficult to align the system time point of the transmitting speaker with the time point marked by the timestamp.

Therefore, the present disclosure seeks to develop an audio playback method in which a system time point of a transmitting speaker is aligned with a time point marked by a timestamp, and accordingly, provides an audio playback system and a transmitting speaker for simultaneous playback of an audio.

### SUMMARY

Following the above paragraphs, compared with the prior art described above, the embodiments of the present disclosure can provide an accurate pairing of a system time point and a beacon time point, so that a speaker can align the beacon time point with the system time point, and then each speaker can play back an audio at a specified time point. In various situations, the speakers can play back the same audio simultaneously, or play back different audios at respective specified time points.

Some embodiments of the present disclosure relate to an audio playback method. The audio playback method comprises following steps of: successively transmitting, by a system on chip, multiple timestamp capturing instructions to a wireless communication chip to command the wireless communication chip to capture multiple corresponding timestamps, respectively; in response to the timestamp capturing instructions, capturing, by the system on chip, multiple corresponding system time points which correspond to the timestamp capturing instructions respectively; generating multiple corresponding time pairs which correspond to the timestamp capturing instructions one by one, according to the corresponding timestamps and the corresponding system time points; and determining, by the system on chip, a system playback time point according to the corresponding time difference which is generated from the time pairs. The capturing, by the system on chip, the multiple corresponding system time points which correspond to the timestamp capturing instructions respectively comprises following steps of: sending, by the wireless communication chip, an input/output signal and a corresponding timestamp currently-captured in the corresponding timestamps to the system on chip through a first input-output interface and a communication interface, respectively, when the wireless communication chip receives each of the timestamp capturing instructions, wherein the first input-output interface and the communication interface are included in the wireless communication chip; and in response to an interrupt signal, capturing, by the system on chip, a current system time point as a corresponding system time point which corresponds to a current timestamp capturing instruction in the timestamp capturing instructions.

Some embodiments of the present disclosure relate to a transmitting speaker. The transmitting speaker comprises a system on chip and a wireless communication chip. The system on chip comprises a first communication interface, an audio playback program, and a wireless communication driver program. The audio playback program is configured to transmit a time pair request. The wireless communication driver program is configured to generate a timestamp capturing instruction to the first communication interface in response to the time pair request. The wireless communication chip comprises a second communication interface, a first interrupt service routine, and a first input-output interface. The second communication interface is electrically connected to the first communication interface, and configured to receive the timestamp capturing instruction and to return a timestamp to the wireless communication driver program. The first interrupt service routine is configured to notify the first input-output interface to generate an input/output signal. The system on chip further comprises a second input-output interface and an interrupt handler. The second input-output interface is electrically connected to the first input-output interface. The second input-output interface receives the input/output signal to trigger an interrupt signal to the interrupt handler; and the interrupt handler is configured to receive the interrupt signal and to initiate capturing of a system time point. The audio playback program is further configured to generate a time difference between the system time point and a time point marked by the timestamp, and to play back an audio at a system playback time point estimated based on the time difference.

Some embodiments of the present disclosure relate to an audio playback system. The audio playback system comprises a transmitting speaker and multiple receiving speakers communicably connected to the transmitting speaker. The transmitting speaker comprises a system on chip and a wireless communication chip, wherein the wireless communication chip is configured to send a first timestamp to the system on chip in response to a timestamp capturing instruction associated with a time pair request. The system on chip comprises an audio playback program. The audio playback program is configured to transmit the time pair request according to a user input. The wireless communication chip comprises a first interrupt service routine, and a first input-output interface. The first interrupt service routine notifies a first input-output interface. The first input-output interface generates an input/output signal to trigger an interrupt signal. The system on chip further comprises a second interrupt service routine. The second interrupt service routine is configured to capture a system time point of the transmitting speaker in response to the interrupt signal. The audio playback program is further configured to generate a time difference between the system time point and a time point marked by a timestamp. The transmitting speaker determines a system playback time point according to the time difference.

### BRIEF DESCRIPTION OF THE DRAWINGS

The content of the present disclosure may be better understood with reference to the embodiments in the subsequent paragraphs and the following drawings.

FIG. 1 shows a schematic diagram of an audio playback system in accordance with some embodiments of the present disclosure.

FIG. 2 shows a schematic diagram of a transmitting speaker in accordance with some embodiments of the present disclosure.

FIG. 3A shows a flow chart of an audio playback method in accordance with some embodiments of the present disclosure.

FIG. 3B shows a flow chart of further details of step 320 in FIG. 3A in accordance with some embodiments of the present disclosure.

FIG. 4 shows a schematic diagram of a signal sending mode in the transmitting speaker in accordance with some embodiments of the present disclosure.

FIG. 5 shows a flow chart of a signal sending mode in the transmitting speaker in accordance with other embodiments of the present disclosure.

### DETAILED DESCRIPTION

The spirit of the present disclosure will be clearly illustrated by the following diagrams and detailed descriptions, and those having ordinary skill in the technical field to which the present disclosure pertains, after understanding the embodiments of the present disclosure, may make alterations and modifications based on the technologies taught in the present disclosure, without departing from the spirit and scope of the present disclosure.

The terms used herein are intended for describing specific embodiments only and are not intended to limit the present disclosure. As used herein, the singular forms such as “one”, “this”, “the”, “aforementioned” and “said” also include plural forms.

The terms “comprise”, “include”, “have”, “contain”, etc. used herein are all open terms, i.e., they mean including but is not limited to.

As used herein, the terms “approximately”, “about”, “or so” or “substantially” should generally mean within 20%, 10%, or 5% of a given value or range. The numerical magnitudes given herein are approximate, meaning that the terms “approximately”, “about”, “or so” or “substantially” can be conjectured in the absence of an explicit stipulation.

The terms used herein, unless otherwise specified, usually have their ordinary meanings used in this field, in the content of the present disclosure and in the special contents. Certain terms used to describe the present disclosure will be discussed below or elsewhere in the Description to provide additional guidance to those skilled in the art in the description of the present disclosure.

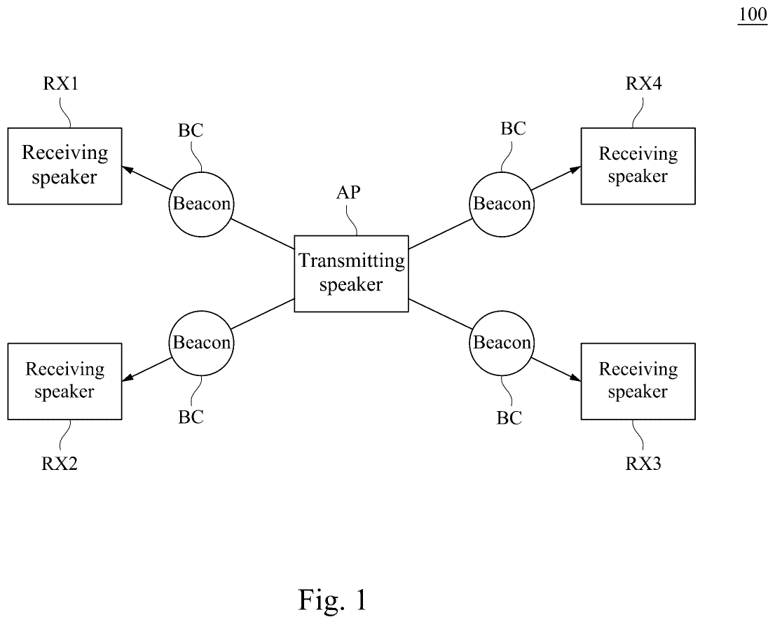

Now, reference is made to FIG. 1. FIG. 1 shows a schematic diagram of an audio playback system 100 in accordance with some embodiments of the present disclosure. As shown in FIG. 1, the audio playback system 100 includes a transmitting speaker AP and multiple receiving speakers RX1-RX4. The transmitting speaker AP is communicably connected to the receiving speakers RX1-RX4. Operationally, the receiving speakers RX1-RX4 receive a beacon signal BC emitted by the transmitting speaker AP, wherein the beacon signal BC includes a timestamp TSC associated with a co-playback time point to further cause the transmitting speaker AP and the receiving speakers RX1-RX4 to play back synchronously. The receiving speakers RX1-RX4 continuously monitor wireless signals and actively receive the beacon signal BC.

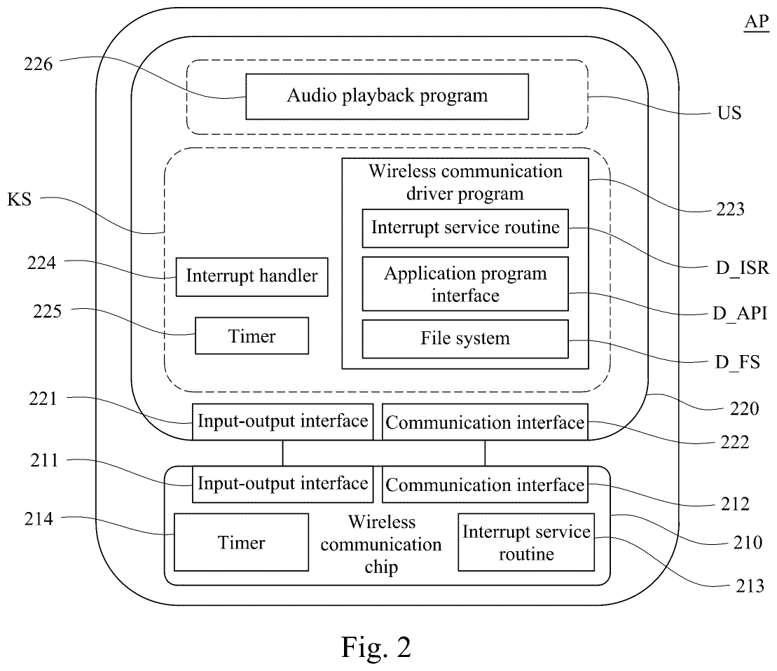

Now, reference is made to FIG. 2. FIG. 2 shows a schematic diagram of a transmitting speaker AP in accordance with some embodiments of the present disclosure. As shown in FIG. 2, the transmitting speaker AP includes a wireless communication chip 210 and a system on chip 220, wherein the wireless communication chip 210 may be, but is not limited to, a Wi-Fi chip. The wireless communication chip 210 includes an input-output interface 211 and a communication interface 212. The system on chip 220 includes an input-output interface 221 and a communication interface 222. The input-output interface 211 is electrically connected to the input-output interface 221. The communication interface 212 is electrically connected to the communication interface 222. In other words, the wireless communication chip 210 and the system on chip 220 are electrically connected to each other through the input-output interfaces 211 and 221 and the communication interfaces 212 and 222.

In some embodiments, the input-output interfaces 211 and 221 are general purpose input/output (GPIO) interfaces. In other words, the input-output interface 211 and the input-output interface 221 can be a GPIO pin and a GPIO port, respectively. In some embodiments, the communication interfaces 212 and 222 are universal serial bus (USB) interfaces. In other words, the communication interfaces 212 and 222 are a USB pin and a USB port, respectively.

In detail, the wireless communication chip 210 further includes an interrupt service routine (ISR) 213. The system on chip 220 further includes a kernel space KS and a user space US. Components in the kernel space KS can control parts of the hardware in the system on chip 220 by means of a machine code, i.e., a low-level programming language, and can directly extract system information, such as a system time point. In addition, the kernel space KS includes a wireless communication driver program 223 and an interrupt handler 224. The wireless communication driver program 223 includes an interrupt service routine D_ISR.

In contrast to the kernel space KS, components in the user space US cannot directly extract the system information, and must make a request to the kernel space KS through a system call to extract the system information. The user space US includes an audio playback program 226. The specific functions and association relationships of the individual components of the wireless communication chip 210 and the individual components of the system on chip 220 are described together with an audio playback method 300 and signal sending modes 400 and 500 in the following paragraphs.

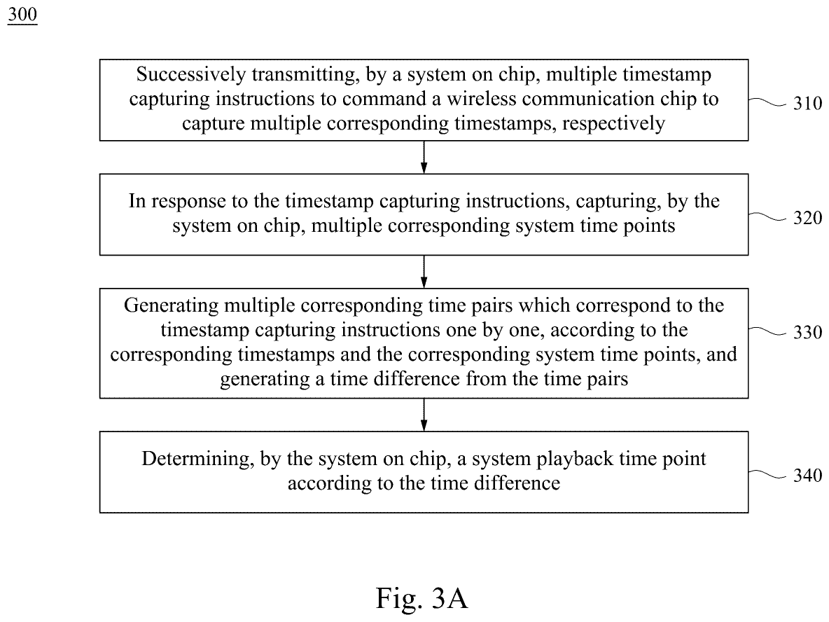

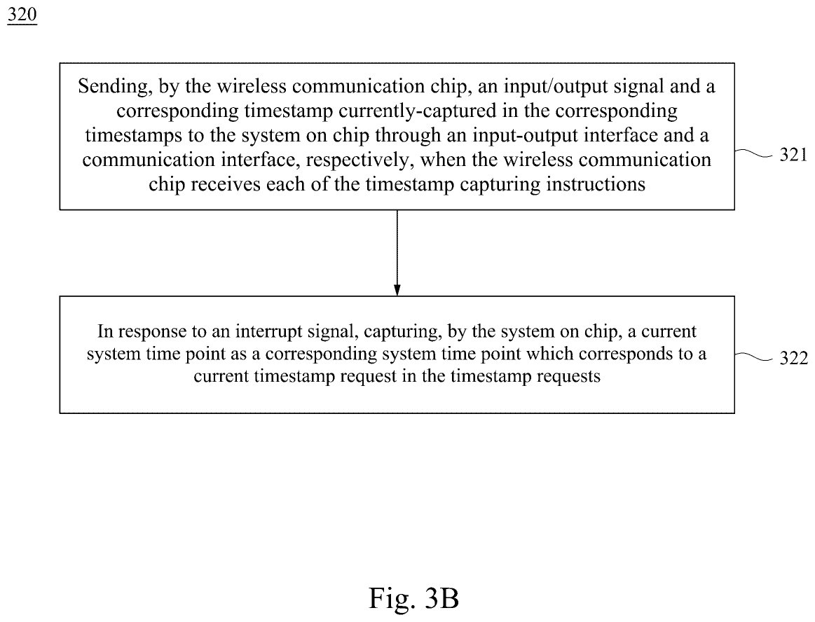

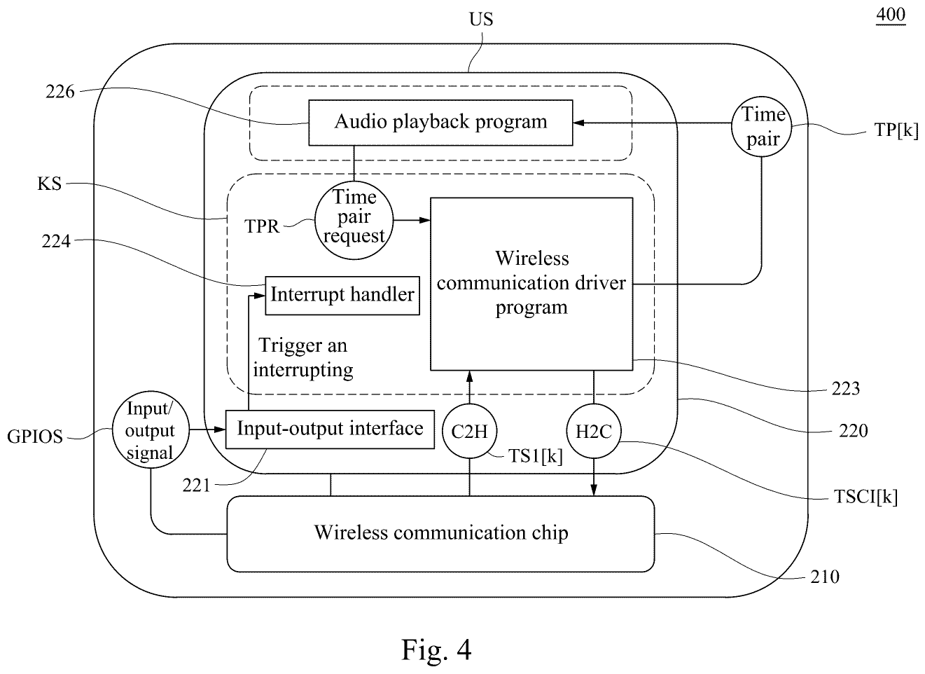

Now, reference is made to FIGS. 1, 2, 3A, 3B and 4 together. FIG. 3A shows a flow chart of an audio playback method 300 in accordance with some embodiments of the present disclosure. FIG. 3B shows a flow chart of further details of step 320 in FIG. 3A in accordance with some embodiments of the present disclosure. FIG. 4 shows a schematic diagram of a signal sending mode 400 in the transmitting speaker AP in accordance with some embodiments of the present disclosure. It should be understood that additional operations may be provided before, during and after the processes shown in FIGS. 3A and 3B, and that some operations described below may be substituted or eliminated for additional embodiments of the method. The order of the operations/processes can be interchangeable. In the drawings and illustrative embodiments, same reference numerals are used to represent same elements. The audio playback method 300 includes steps 310, 320, 330 and 340 below with reference to the signal sending mode 400, wherein step 320 includes substeps 321 and 322.

First, at step 310, a system on chip 220 successively transmits multiple timestamp capturing instructions to a wireless communication chip 210 to command the wireless communication chip 210 to capture multiple corresponding timestamps TS1, respectively. In detail, an audio playback program 226 of the system on chip 220 successively transmits multiple time pair requests TPR to a wireless communication driver program 223 of the system on chip 220. In response to the time pair requests TPR, the wireless communication driver program 223 successively generates the timestamp capturing instructions TSCI, and transmits the timestamp capturing instructions TSCI to the wireless communication chip 210. Then, in response to the timestamp capturing instructions TSCI, the wireless communication chip 210 successively captures the multiple corresponding timestamps TS1.

In some embodiments, the wireless communication driver program 223, after receiving the time pair requests TPR, transmits a timestamp request to the wireless communication chip 210. The wireless communication chip 210, after receiving the timestamp request, transmits an input/output signal GPIOS to notify the system on chip 220 and returns the corresponding timestamps TS1 to the wireless communication driver program 223 in the form of C2H. The system on chip 220, after receiving the input/output signal GPIOS, triggers an interrupt signal, and the interrupt handler 224 calls an interrupt service routine D_ISR registered by the wireless communication driver program 223 to capture system time points SysT. Next, the wireless communication driver program 223 undergoes the captured system time points SysT and the corresponding timestamps TS1, and returns the system time points SysT and the corresponding timestamps TS1 to the audio playback program 226.

In other words, the audio playback program 226 transmits the time pair requests TPR at different time points. The wireless communication driver program 223 generates and transmits the timestamp capturing instructions TSCI at different time points. The wireless communication chip 210 captures the corresponding timestamps TS1 at different time points. The time pair requests TPR are in one-to-one correspondence with the timestamp capturing instructions TSCI. The timestamp capturing instructions TSCI are in one-to-one correspondence with the corresponding timestamps TS1.

For example, for a positive integer n, the time pair requests TPR include time pair requests TPR[1]-TPR[n]. The timestamp capturing instructions TSCI includes timestamp capturing instructions TSCI[1]-TSCI[n]. The corresponding timestamps TS1 include corresponding timestamps TS1[1]-TS1[n]. The timestamp capturing instructions TSCI[1]-TSCI[n] correspond to the time pair requests TPR[1]-TPR[n], respectively. The corresponding timestamps TS1[1]-TS1[n] correspond to the time pair requests TPR[1]-TPR[n], respectively. The corresponding timestamps TS1[1]-TS1[n] correspond to the time pair requests TPR[1]-TPR[n], respectively.

In addition, the timestamp capturing instructions TSCI[1]-TSCI[n] are transmitted to the wireless communication chip 210 at the transmit time points t1-tn, respectively, so that the wireless communication chip 210 captures he corresponding timestamps TS1[1]-TS1[n] at the capture time points tc1-tcn, respectively.

In detail, for each of the time pair requests TPR, as shown in FIG. 4, after the audio playback program 226 transmits the time pair request TPR[k] to the wireless communication driver program 223, in response to the time pair request TPR[k], the wireless communication driver program 223 generates the timestamp capturing instruction TSCI[k], wherein k=1, 2, . . . , or n, and k depend on a current transmit time point tk. For example, for a transmit time point t3, k=3. In other words, the time pair request TPR[3] is transmitted to the wireless communication driver 223 at the transmit time point t3, and the wireless communication driver 223 generates the timestamp capturing instruction TSCI[3] accordingly.

Further, the timestamp capturing instruction TSCI[k] is included in a host to client (H2C) packet. The multiple timestamp capturing instructions TSCI are included in multiple H2C packets, respectively. The H2C packets are then sent through a communication interface 212 to a communication interface 222 (refer to FIG. 2) to enter the wireless communication chip 210, wherein the H2C packet has a packet structure different from that of general wi-fi packets. The H2C packet is unidirectionally sent from the system on chip 220 to the wireless communication chip 210, while the wi-fi packets are sent between the wireless communication chips 210.

In such a way, the audio playback program 226 of the system on chip 220 successively transmits the multiple time pair requests TPR to the wireless communication driver program 223 of the system on chip 220. In response to the time pair requests TPR, the wireless communication driver program 223 successively generates the timestamp capturing instructions TSCI and successively transmits the timestamp capturing instructions TSCI to the wireless communication chip 210.

Reference is made to FIG. 4 again. After the H2C packet including the timestamp capturing instruction TSCI[k] enters the wireless communication chip 210, the wireless communication chip 210 captures the corresponding timestamp TS1[k] in response to the timestamp capturing instruction TSCI[k]. In some embodiments, the wireless communication chip 210 further includes a timer 214, and the corresponding timestamp TS1[k] is captured from the timer 214.

At step 320, in response to the timestamp capturing instructions TSCI, the system on chip 220 captures multiple corresponding system time points SYsts which correspond to the timestamp capturing instructions TSCI, respectively. For example, the corresponding system time points SysT include corresponding system time points SysT[1]-SysT[n], and the corresponding system time point SysT[1] corresponds to the timestamp capturing instruction TSCI[1]. The corresponding system time point SysT[2] corresponds to the timestamp capturing instruction TSCI[2], and so on. The corresponding system time point SysT[n] corresponds to the timestamp capturing instruction TSCI[n]. In addition, in some embodiments, the system on chip 220 further includes a timer 225, and the corresponding system time points SysT[1]-SysT[n] are captured from the timer 225. In some embodiments, step 320 includes substeps 321 and 322.

At substep 321, as shown in FIG. 4, when the wireless communication chip 210 receives each of the timestamp capturing instructions TSCI, the wireless communication chip 210 respectively sends an input/output signal GPIOS and the corresponding timestamp TS1[k] currently-captured in the corresponding timestamps TS1 to the system on chip 220 through the input-output interface 211 and the communication interface 212, wherein the corresponding timestamp TS1[k] currently-captured is a corresponding timestamp captured at a current capture time point tck in response to the current timestamp capturing instruction TSCI[k], and the current timestamp capturing instruction TSCI[k] is a timestamp capturing instruction generated in response to the time pair request TPR[k] transmitted by the system on chip 220 at a current transmit time point tk.

In some embodiments, the input/output signal GPIOS is generated by the input-output interface 211 when the wireless communication chip 210 receives each of the timestamp capturing instructions TSCI.

In some embodiments, for the input/output signal GPIOS, when each of the timestamp capturing instructions TSCI is received, the interrupt service routine 213 of the wireless communication chip 210 first notifies the input-output interface 211, and then the input-output interface 211 generates the input/output signal GPIOS to the input-output interface 221. For example, when the input-output interface 211 is a GPIO pin, accordingly, the interrupt service routine 213 notifies the input-output interface 211, and then the input-output interface 211 generates a pulse signal and transmits the pulse signal as the input/output signal GPIOS to the GPIO pin. The pulse signal is then sent from the input-output interface 211 to the input-output interface 221 (refer to FIG. 2), and in response to this pulse signal, an interrupt signal is triggered to enter the interrupt handler 224 of the system on chip 220.

For the corresponding timestamp TS1[k], in detail, as shown in FIG. 4, the corresponding timestamp TS1[k] is included in a client to host (C2H) packet, and the C2H packet is sent through the communication interface 212 to the communication interface 222 (refer to FIG. 2) to enter the wireless communication driver program 223 of the system on chip 220. Similar to the H2C packet, the C2H packet has a packet structure different from that of general wi-fi packets. However, the C2H packet is unidirectionally sent from the wireless communication chip 210 to the system on chip 220, while the wi-fi packet is sent between the wireless communication chips 210. By sending the C2H packet, the corresponding timestamp TS1[k] is sent to the wireless communication driver program 223.

In addition, in some embodiments, using the C2H packet to send the corresponding timestamp TS1[k] is performed when the pulse signal acts as the input/output signal GPIOS to drive the GPIO interface 211. In other words, in response to the interrupt service routine 213, the generation of the input/output signal GPIOS by the input-output interface 211 and the sending of the corresponding timestamp TS1[k] to the system on chip 220 through the communication interface 212 are performed simultaneously.

At substep 322, in response to the interrupt signal, the system on chip 220 captures the current system time point SysT[k] as a corresponding system time point which corresponds to the current timestamp capturing instruction TSCI[k] in the timestamp capturing instructions TSCI.

In detail, in some embodiments, as shown in FIG. 4, the interrupt handler 224, after receiving the interrupt signal, executes the interrupt service routine D_ISR registered by the wireless communication driver program 223 of the system on chip 220. (Refer to FIG. 2). Then, the interrupt service routine D_ISR SysT[k] captures the current system time point as the corresponding system time point which corresponds to the current timestamp capturing instruction TSCI[k].

Next, at step 330, according to the corresponding timestamps TS1 and the corresponding system time points Sys_T, multiple corresponding time pairs which correspond to the timestamp capturing instructions TSCI one by one are generated. A time difference is then generated from the time pairs, and to play back the audio AD at the system playback time point estimated based on the time difference.

In detail, the wireless communication driver program 223 further pairs the corresponding system time points Sys_T with the corresponding timestamps TS1 to generate multiple time pairs TP. In other words, Sys_T[1] and TS1[1] form a time pair TP[1]. Sys_T[2] and TS1[2] form a time pair TP[2], and so on. Sys_T[n] and TS1[n] form a time pair TP[n].

The audio playback program 226 then extracts the time pairs TP through the wireless communication driver program 223, wherein the time pairs TP include the time pairs TP[1]-TP[n]. As shown in FIG. 4, in some embodiments, in response to the current time pair instruction TPR[k], the wireless communication driver program 223 will provide the current time pair TP[k] which corresponds to the current time pair instruction TPR[k] to the audio playback program 226. For each of the time pairs TPR, the current time pair TP[k] is provided to the audio playback program 226 in the same manner. In this way, the audio playback program 226 obtains the time pars TP[1]-TP[n].

In some embodiments, the audio playback program 226 transmits time pair requests TPR at multiple predetermined time points tr1-trn. In some embodiments, there is a time interval delta_t3 between any adjacent two of the predetermined time points tr1-trn (e.g., the predetermined time points trk and tr(k+1)). In other words, the time pair requests TPR are periodically transmitted.

In some embodiments, the audio playback program 226 issues the time pair requests TPR at multiple predetermined time points to extract the time pairs TP. In other words, the extraction of the current time pair TP[k] can be performed successively at the predetermined time points tp_1-tp_n. In some embodiments, there is a constant time interval delt_t1 between any adjacent two of the predetermined time points tp_1-tp_n. In other words, the time difference (tp_2−tp_1), the time difference (tp_3−tp_2), the . . . , and the time difference (tp_n−tp_n−1) are the same. In other words, the audio playback program 226 periodically performs the extraction of the current time pair TP[k]. In some embodiments, the time interval delta_t1 is equal to the interval delta_t3.

In addition, in more detail, in some embodiments, the wireless communication driver program 223 further includes an application program interface D_API (refer to FIG. 2). The time pair requests TPR are transmitted to the application program interface D_API, and then the application program interface provides the current time pair TP[k] to the audio playback program 226.

In some embodiments, the wireless communication driver program 223 does not include the application program interface D_API, but further includes a file system D_FS (refer to FIG. 2), e.g., proc entry. The time pair requests TPR are transmitted to the file system D_FS, and then the file system D_FS provides the current time pair TP[k] to the audio playback program 226.

In some embodiments, the wireless communication driver program 223 further includes an application program interface D_API and the file system D_FS (refer to FIG. 2). The time pair requests TPR are optionally transmitted to the application program interface D_API or the file system D_FS, and then the application program interface D_API or the file system D_FS provides the current time pair TP[k] to the audio playback program 226, wherein the application program interface D_API is provided by the wireless communication driver program 223 itself, and the file system D_FS is registered by the wireless communication driver program 223 from an operating system.

After the above operations are performed, step 330 is finally completed by the audio playback program 226 generating the multiple corresponding time pairs according to the corresponding timestamps TS1 and the corresponding system time points Sys_T.

At step 340, the system on chip 220 determines the system playback time point tp_sys according to the corresponding time pairs. In detail, according to the corresponding time pairs, the audio playback program 226 can calculate a time difference TD_f between a correct system time point and an emission time point marked by a timestamp. In some embodiments, the number of the time pair requests TPR before the operation of generating the corresponding time difference is performed may be set above 20 to ensure that the time difference TD_f has sufficient accuracy.

In addition, an audio playback begins after the audio playback program 226 generates the time difference TD_f from the corresponding time pairs. For a period of time after the time difference TD_f is obtained, the audio playback system 100 does not need to perform a clock synchronization operation with the timestamp TSC of the beacon BC. The transmitting speaker AP actively transmits the beacon BC at a set time interval (about 102.4 milliseconds). The content of the beacon BC includes the timestamp TSC. In some embodiments, the transmitting speaker AP continuously transmits the beacon BC, regardless of whether the clock synchronization operation is performed, so that the audio playback system 100 can perform the clock synchronization by means of this mechanism. When the audio playback is performed, as shown in FIG. 1, the transmitting speaker AP transmits an audio AD to be played back (not shown) to the receiving speakers RX1-RX4. The audio AD includes a co-playback time point t_tsc.

Next, the audio playback program 226 determines the system playback time point tp_sys for playing back the audio AD according to the co-playback time point t_tsc and the time difference TD_f. In detail, the time difference Td_f is subtracted from the co-playback time point t_tsc to obtain the system playback time point tp_sys. Finally, the transmitting speaker AP plays back the audio AD at the system playback time point tp_sys. In addition, the receiving speakers RX1-RX4 also determine their respective AD playback time points according to the co-playback time point t_tsc.

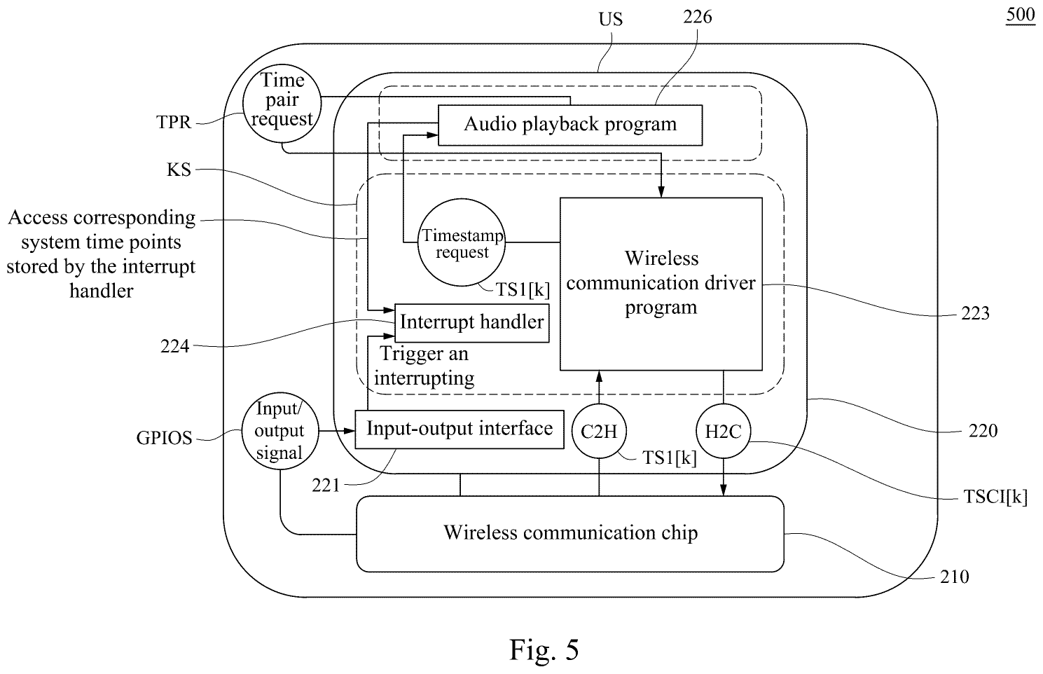

Now, reference is made to FIG. 5. FIG. 5 shows a flow chart of a signal sending mode 500 in the transmitting speaker in accordance with other embodiments of the present disclosure. The audio playback method 300 can also be implemented in the signal sending mode 500. The audio playback method 300 implemented in a signal sending mode 400 differs from the audio playback method 300 implemented in the signal sending mode 500 in that the interrupt handler 224, instead of the wireless communication driver program 223, performs the operation of capturing the corresponding system time points Sys_T at substep 322, and the audio playback program 226 must obtain the corresponding timestamps TS1 from the wireless communication driver program 223 and obtain the system time points Sys_T from the interrupt handler 224, respectively. The other operations of the audio playback method 300 implemented in the signal sending mode 400 are not different from those of the audio playback method 300 implemented in the signal sending mode 500, and are therefore not detailed. The operation of capturing the corresponding system time points at substep 322 performed in the signal sending mode 500 and the operation of pairing the time pairs TP at step 330 performed in the signal sending mode 500 are detailed below.

With respect to the operation of capturing the corresponding system time points at substep 322 and the operation of pairing the time pairs TP at step 330, in some embodiments, as shown in FIG. 5, after the interrupt signal is received, the interrupt handler 224 captures the current system time point SysT[k] as the corresponding system time point which corresponds to the current timestamp capturing instruction [k]. Next, the audio playback program 226 reads the system time points Sys_T obtained by the interrupt handler 224 and pairs the system time points Sys_T with the corresponding timestamps TS1 to generate multiple time pairs TP. In some embodiments, the audio playback program 226, after receiving the timestamp TS1 of the wireless communication driver program 223, additionally accesses the system time points SysT captured by the interrupt handler 224 to make its own pairing.

Now, reference is made to FIG. 2 again. Based on the above operations, the specific functions and association relationships of the individual components of the wireless communication chip 210 and the individual components of the system on chip 220 are listed below. The interrupt service routine 213 is configured to notify the input-output interface 211 first. The input-output interface 211 is configured to generate the input/output signal GPIOS in response to the notification of the interrupt service routine 213. The communication interface 212 is configured to send the timestamps TS1[1]-TS1[n]. The interrupt handler 224 is configured to receive the interrupt signal triggered by the input/output signal GPIOS received by the input-output interface 221 and initiates the capturing of a system time point. The wireless communication driver program 223 is configured to receive the timestamps TS1[1]-TS1[n] through the communication interface 212. The interrupt service routine D_ISR is configured to perform the capturing of the system time in response to a call from the interrupt handler 224 and to pair the system time points SysT[1]-SysT[n] with the timestamps TS1[1]-TS1[n]. The application program interface D_API and the file system D_FS are configured to provide the system time points and the timestamps which are paired to the audio playback program. The audio playback program 226 is configured to generate the time difference generated from the time pairs which consist of the system time points SysT[1]-SysT[n] and the time points t1-tn marked by the timestamps TS1[1]-TS1[n], and to play back the audio AD at the system playback time point tp_sys estimated based on the time difference.

In some embodiments, a system interrupting is triggered when the system on chip 220 receives the input/output signal GPIOS.

In some embodiments, extraction of the time pairs TP by the audio playback program 226 further includes: requesting, by the audio playback program 226, the corresponding timestamps TS1 from the wireless communication driver program 223, taking the corresponding system time points SysT from the interrupt handler 224, and pairing the corresponding system time points SysT with the corresponding timestamps TS1 to generate the time pairs TP, wherein according to the corresponding timestamps TS1 and the corresponding system time points SysT, the corresponding time difference is generated, which includes: extracting, by the audio playback program 226, the corresponding timestamps TS1 through the wireless communication driver program 223, and generating the corresponding time difference according to the time pairs TP.

In summary, according to the present disclosure, the input-output interfaces 211 and 221 are added to the transmitting speaker AP to provide a channel between the wireless communication chip 210 and the system on chip 220 in addition to the communication interfaces 212 and 222. In such a configuration, the wireless communication chip 210 can send the input/output signal GPIOS to the system on chip 220 through the input-output interface 211 to notify the system on chip 220 to capture the system time points. The system time points do not need to be captured after the timestamps are sent through the communication interfaces 212 and 222 to the wireless communication driver program 223, thereby solving the problem that the system time points of the transmitting speaker cannot align with the time points marked by the timestamps in the prior art. In this way, the audio playback system 100 can use the input/output signals GPIOS to timely provide accurate system time points SysT for being paired with beacon time points, thereby achieving an optimal alignment. The transmitting speaker AP can play back the audio AD within a specified period of time.

Although the present disclosure has been disclosed as above in embodiments, the present disclosure does not preclude other possible embodiments. Therefore, the scope of protection of the present disclosure shall be as defined in the Claims below and shall not be limited by the foregoing embodiments.

Those skilled in the art may make some changes and embellishments within the spirit and scope of the present disclosure. Based on the foregoing embodiments, all changes and embellishments made to the present disclosure also fall with the scope of protection of the present disclosure.

What is claimed is:

1. An audio playback method, comprising:
successively transmitting, by a system on chip, a plurality of timestamp capturing instructions to a wireless communication chip to command the wireless communication chip to capture a plurality of corresponding timestamps, respectively;
in response to the plurality of timestamp capturing instructions, capturing, by the system on chip, a plurality of corresponding system time points which correspond to the plurality of timestamp capturing instructions respectively, comprising:
when the wireless communication chip receives each of the plurality of timestamp capturing instructions, sending, by the wireless communication chip, an input/output signal and a corresponding timestamp currently-captured in the plurality of corresponding timestamps to the system on chip through an first input-output interface and a communication interface, respectively, to trigger a system interrupting when the system on chip receives the input/output signal,
wherein the first input-output interface and the communication interface are included in the wireless communication chip; and
in response to an interrupt signal, capturing, by the system on chip, a current system time point as a corresponding system time point which corresponds to a current timestamp capturing instruction in the plurality of timestamp capturing instructions;
generating a single time difference for the plurality of timestamp capturing instructions, with each of the plurality of timestamp capturing instructions corresponding one-to-one with the respective timestamps and the system time points; and
determining, by the system on chip, a system playback time point according to the time difference.

2. The audio playback method of claim 1, further comprising:
generating, by the wireless communication chip, the input/output signal when the wireless communication chip receives each of the plurality of timestamp capturing instructions, comprising:
notifying the first input-output interface to generate the input/output signal to a second input-output interface through an interrupt service routine of the wireless communication chip; and
in response to the input/output signal, triggering the system on chip to generate the interrupt signal.

3. The audio playback method of claim 2, wherein the interrupt service routine is configured to notify the first input-output interface.

4. The audio playback method of claim 2, wherein the input/output signal and the first input-output interface are respectively a pulse signal and a GPIO (general purpose input/output) pin.

5. The audio playback method of claim 1, wherein the successively transmitting, by the system on chip, the plurality of timestamp capturing instructions to the wireless communication chip comprises:
successively transmitting, by an audio playback program of the system on chip, a plurality of time pair requests to a wireless communication driver program of the system on chip; and
in response to the plurality of time pair requests, successively generating, by the wireless communication driver program, the plurality of timestamp capturing instructions and successively transmitting the plurality of timestamp capturing instructions to the wireless communication chip, wherein the plurality of timestamp capturing instructions correspond to the plurality of time pair requests one by one.

6. The audio playback method of claim 5, wherein transmissions of the plurality of time pair requests are respectively implemented at a plurality of predetermined time points.

7. The audio playback method of claim 6, wherein a time interval is between any two of the plurality of predetermined time points.

8. The audio playback method of claim 1, wherein the successively transmitting, by the system on chip, the plurality of timestamp capturing instructions to the wireless communication chip comprises:
including the plurality of timestamp capturing instructions in a plurality of first packets, respectively; and
successively sending the plurality of first packets to the wireless communication chip.

9. The audio playback method of claim 8, wherein the sending, by the wireless communication chip, the corresponding timestamp currently-captured to the system on chip through the communication interface when the wireless communication chip receives each of the plurality of timestamp capturing instructions comprises:
including the corresponding timestamp currently-captured in a second packet; and
sending the second packet through the communication interface to a wireless communication driver program of the system on chip.

10. The audio playback method of claim 9, wherein the in response to the interrupt signal, capturing, by the system on chip, the current system time point as the corresponding system time point which corresponds to the current timestamp capturing instruction comprises:
capturing, by an interrupt handler, the current system time point as the corresponding system time point which corresponds to the current timestamp capturing instruction; and
the audio playback method further comprises:
pairing the plurality of corresponding system time points with the plurality of corresponding timestamps to generate a plurality of time pairs,
wherein the generating the time difference which corresponds to the plurality of timestamp capturing instructions one by one, according to the plurality of corresponding system time points and the plurality of corresponding timestamps comprises:
extracting, by an audio playback program, the plurality of time pairs, and generating a single time difference for the plurality of timestamp capturing instructions, with each of the plurality of timestamp capturing instructions corresponding one-to-one with the plurality of time pairs.

11. The audio playback method of claim 10, wherein the extracting, by the audio playback program, the plurality of time pairs further comprises:
requesting, by the audio playback program, the plurality of corresponding timestamps from the wireless communication driver program, taking the plurality of corresponding system time points from the interrupt handler, and pairing the plurality of corresponding system time points with the plurality of corresponding timestamps to generate the plurality of time pairs,
wherein the generating the corresponding time difference which corresponds to a plurality of beacon transmissions one by one, according to the plurality of corresponding timestamps and the plurality of corresponding system time points comprises:
extracting, by the audio playback program, the plurality of corresponding timestamps through the wireless communication driver program, and generating the corresponding time difference according to the plurality of time pairs.

12. The audio playback method of claim 9, wherein the in response to the interrupt signal, capturing, by the system on chip, the current system time point as the corresponding system time point which corresponds to the current timestamp capturing instruction comprises:
calling, by an interrupt handler of the system on chip, an interrupt service routine of the wireless communication driver program; and
capturing, by the interrupt service routine, the current system time point as the corresponding system time point which corresponds to the current timestamp capturing instruction.

13. The audio playback method of claim 12, further comprising:
pairing the plurality of corresponding timestamps with the plurality of corresponding system time points by the wireless communication driver program to generate a plurality of time pairs, and
according to the plurality of corresponding system time points and the plurality of corresponding timestamps, generating the corresponding time difference which corresponds to the plurality of corresponding timestamp capturing instructions one by one, comprising:
extracting, by an audio playback program, the plurality of time pairs through the wireless communication driver program, and generating the corresponding time difference which corresponds to the plurality of timestamp capturing instructions one by one according to the plurality of time pairs.

14. The audio playback method of claim 13, wherein the extracting, by the audio playback program, the plurality of time pairs through the wireless communication driver program comprises:
optionally transmitting, by the audio playback program, a time pair request to an application program interface or a file system of the wireless communication driver program; and
in response to the time pair request, sending, by the application program interface or the file system, the plurality of time pairs to the audio playback program.

15. A transmitting speaker, comprising:
a system on chip, comprising:
a first communication interface;
an audio playback program, configured to transmit a time pair request; and
a wireless communication driver program, configured to generate a timestamp capturing instruction to the first communication interface in response to the time pair request; and
a wireless communication chip, comprising:
a second communication interface, electrically connected to the first communication interface, and configured to receive the timestamp capturing instruction and to return a timestamp to the wireless communication driver program;
a first interrupt service routine, configured to notify a first input-output interface to generate an input/output signal; and
wherein the system on chip further comprises:
a second input-output interface, electrically connected to the first input-output interface, and configured to receive the input/output signal to trigger an interrupt signal to an interrupt handler; and
the interrupt handler, configured to receive the interrupt signal and initiate a capturing of a system time point,
wherein the audio playback program is further configured to generate a time difference between the system time point and a time point marked by the timestamp, and to play back an audio at a system playback time point estimated based on the time difference.

16. The transmitting speaker of claim 15, wherein the wireless communication driver program comprises:
a second interrupt service routine, configured to perform the capturing of the system time point in response to a call from the interrupt handler.

17. The transmitting speaker of claim 15, wherein the interrupt handler is further configured to pair the system time point with the timestamp; and the wireless communication driver program comprises:
an application program interface and a file system, configured to provide the system time point and the timestamp which are paired to the audio playback program.

18. An audio playback system, comprising:
a transmitting speaker, comprising:
a system on chip, comprising:
an audio playback program, configured to transmit a time pair request; and
a wireless communication chip, configured to send a first timestamp to the system on chip in response to a timestamp capturing instruction associated with the time pair request, wherein the wireless communication chip comprises:
a first interrupt service routine, configured to notify a first input-output interface; and
the first input-output interface that generates an input/output signal to trigger an interrupt signal, wherein the system on chip further comprises:
a second interrupt service routine, configured to capture a system time point of the transmitting speaker in response to the interrupt signal, wherein the audio playback program is further configured to generate a time difference between the system time point and a time point marked by the first timestamp; and
a plurality of receiving speakers, communicably connected to the transmitting speaker respectively, and configured to receive a plurality of first beacon signals,
wherein the transmitting speaker determines a system playback time point according to the time difference.

19. The audio playback system of claim 18, wherein when an audio playback is performed, the transmitting speaker is further configured to send a beacon including a second timestamp and an audio to the plurality of receiving speakers, and the transmitting speaker plays back the audio at the system playback time point estimated based on the time difference and the second timestamp.
